(19) United States
(12) Patent Application Publication
(10) Pub. No.: US 2011/0161131 A1
(43) Pub. Date: Jun. 30, 2011

(54) Energy Saving Assistance System and Energy Saving Assistance Program

(75) Inventors: Hirotaka TAKAHASHI, Hitachinaka (JP); Shoji Suzuki, Tokyo (JP); Nobuo Tomita, Tokyo (JP); Tatsunori Takahashi, Tokyo (JP); Makoto Shimodera, Misato (JP); Rin Yan, Tokyo (JP)

(73) Assignees: Hitachi, Ltd., Tokyo (JP); Hitachi Building Systems Co., Ltd., Tokyo (JP)

(21) Appl. No.: 12/977,388

(22) Filed: Dec. 23, 2010

(30) Foreign Application Priority Data
Dec. 25, 2009 (JP) 2009-293715

(51) Int. Cl. G06Q 10/00

(52) U.S. Cl. 705/7.24

(57) ABSTRACT

The present invention provides an energy saving assistance technique for creating a plan for selecting an energy saving solution to continuously clear a target value of energy saving in accordance with the Law Concerning the Rational Use of Energy and a time when to introduce this selected solution with consideration through plural bases in total, in accordance with users need such as priority order of base selection. The present invention includes a user setting section for setting users need including a target value such as an annual rate of energy saving for every year and a priority order of base selection when carrying out an energy saving solution, an elemental effect calculation section for calculating an energy saving effect due to replacement with energy saving equipment (energy saving solution) for every base, and a consolidation for creating and outputting, based on the energy saving effect calculated for every base, an energy saving plan that continuously clears a target such as an annual rate of energy saving for every year and satisfies the users need.

### CROSS-REFERENCE TO RELATED APPLICATION

This application claims the foreign priority benefit under 35 U.S.C. §119 of Japanese Patent Application No. 2009-293715 filed on Dec. 25, 2009, the disclosure of which is incorporated herein by reference.

### BACKGROUND OF THE INVENTION

1. Field of the Invention

The present invention relates to an energy saving assistance system and an energy saving assistance program, particularly relates to an energy saving assistance system and an energy saving assistance program for creating an energy saving plan.

2. Description of the Related Art

It has been considered that one of causes of the global warming is CO₂, and in order to reduce progression of the global warming, various energy saving actions have been attempted. Turning off the light in an empty room in one's house or turning off the light during lunch time in an office is one of energy saving solutions causing no cost. However, in some cases, for the purpose of energy saving, existing equipment or device that has been used is required to be replaced with new one of energy saving type, which may cause additional economic load on a user, and such a case may even hinder an energy saving promotion. In addition, there is another problem that a user cannot grapes how much effect of the energy saving is achieved even though new equipment or device of energy saving type is introduced. There is a further problem that a user who is not familiar with mechanical devices does not know how to carry out such an energy saving action at all. There are disclosed techniques to address the above problems in JP2001-56804A and JP2001-344412A.

In the technique disclosed in JP2001-56804A, the system represents to a user a list of available energy saving solutions so that the user selects one or some of the energy saving solutions. After the user introduces the selected energy saving solution, the system monitors all the time whether or not the energy saving is achieved as initially estimated based on the estimated energy reduction expected through the selected energy saving solution and the actually measured energy consumption, and informs the user of results of the monitoring, so that the user can know how much effect of the energy saving has been achieved. Then, the system pays a price for the energy reduction that has been reduced through the energy saving solution into a given bank account, which enables the user to buy an additional energy saving device at a higher price more easily.

A technique disclosed in JP2001-344412A is a technique that is developed from the technique disclosed in JP2001-56804A. JP2001-56804β also discloses a technique to suggest a time when to introduce an additional energy saving solution. In order to calculate the above introduction time, the system in the technique of JP2001-56804A calculates “a remaining debt of existing energy saving equipment or devices and cost for energy saving devices planned to be newly introduced” and “cost reduction through the existing devices and newly introduced energy saving devices”, and based on this calculation the system informs a user of an energy saving device whose cost recovery period reaches five or six years and a time when to introduce a new energy saving device.

In Japan, according to the Law Concerning the Rational Use of Energy since 2010, every company is obligated to save energy per annual rate of 1%. However, there is a problem that prior arts disclosed in such as JP2001-56804A and JP2001-344412A are not conforming with this Law Concerning the Rational Use of Energy. Specifically, according to the Law Concerning the Rational Use of Energy, the energy saving target is getting stricter year by year, but these prior arts describe nothing about shifting of the energy saving target in accordance with Law Concerning the Rational Use of Energy.

Since the Law Concerning the Rational Use of Energy obligates every company to achieve energy saving per annual rate of 1%, a company having dozens or hundreds of bases is required to achieve energy saving per annual rate of 1% through these bases in total. Thus, each company should carry out an energy saving action through plural bases in total. However, the above prior arts describe nothing about a solution to address a problem that may occur when carrying out an energy saving action through plural bases of a company in total (for example, users need to focus energy saving on a particular base such as an energy saving model building; to set the priority order in selecting an energy solution (energy saving equipment or device); or to leave budget behind as little as possible if the budget for a energy saving action is estimated in advance).

The applicant of the present invention has filed JP 2009-45036 that discloses a technique of creating an energy saving plan to comply with an energy saving target that varies year by year, and suggesting to a user an energy saving action and a time when to introduce this energy saving action. However, in JP 2009-45036, a sufficient consideration has not been made in creating an energy saving plan in accordance with users need to focus an energy saving action on a particular base such as an energy saving model building; to set the priority order in selecting an energy solution (energy saving equipment or devices); or to leave budget behind as little as possible if the budget for a energy saving action is estimated in advance.

The present invention has an object to provide an energy saving assistance system and an energy saving assistance program for creating a plan to select an energy saving solution to continuously clear an annual energy saving target in accordance with the Law Concerning the Rational Use of Energy and a time to introduce this selected solution with consideration through plural bases in total, in accordance with users need wishing to preferentially carry out an energy saving action on a particular base such as an energy saving model building; wishing a priority order in selecting an energy solution (energy saving equipment or devices); or wishing to leave budget behind as little as possible if the budget for an energy saving solution is estimated in advance.

Other problems than the above-mentioned problems will be apparent from descriptions of the specification and the attached drawings of the present invention.

### SUMMARY OF THE INVENTION

To solve the above problems, when creating an energy saving plan through plural bases in total, the present invention provides (A) a “user setting section” for setting users need including a target reduction such as an annual rate of energy saving for every year, a priority order of base selection, a priority order of energy saving solution selection, and an estimated budget when carrying out an energy saving solution, (B) an “elemental effect calculation section” for calculating an energy saving effect due to replacement with energy saving equipment (energy saving solution) for every base, (C) a “consolidation section” for creating and outputting, based on the energy saving effect calculated for every base, an energy saving plan that continuously clears the target reduction such as an annual rate of energy saving for every year and satisfies the users need.

First, on (A) the user setting section, a user sets a target reduction of an annual rate of energy saving that is a reduction rate relative to energy consumption for a reference year, and the priority order of base selection, the priority order of energy saving solution selection and estimated budget when carrying out an energy saving solution.

Next, (B) the elemental effect calculation section calculates an energy saving effect for every energy saving solution for every base (for every energy saving facility or for every energy saving equipment), and sends data to (C) the consolidation section.

(C) The consolidation section receives all the data concerning energy saving effect for every energy saving solution for every base, and from all the data, selects an energy saving solution that satisfies the users need specified by the user on the user setting section, and lists up these energy saving solutions. As for definition of a time when to introduce an appropriate energy saving solution among this list, such a time is defined as the time when to introduce the energy saving solution when a transit of the energy consumption after introducing the energy saving solution continuously satisfies the target value of the annual rate of energy saving set on (A) the user setting section, and goes as close to the target value of the annual rate of energy saving as possible. If the estimated budge has leeway, an energy saving solution may be carried out ahead of schedule with the budget left behind as little as possible, so that the target value of the annual rate of energy saving can be cleared more easily in and after the next year. Finally, as the energy saving plan, a pair of the energy saving solution and the time when to introduce the energy saving solution for every base is output.

A summation of estimated energy consumption after introducing the energy saving solution for every base is calculated, and output this calculated value as a transit of the energy consumption through all the plural bases along with the above garget value.

The present invention may employ the following configuration.

(1) The present invention provides an energy saving assistance system that includes a program that runs on at least one computer, and creates an energy saving plan for defining time when to introduce an energy saving solution implemented by installing an energy saving equipment. The program includes: a user setting section for setting as users need a target reduction of energy consumption through all of plural bases for every year and a priority order of selecting from the plural bases a base where an energy saving solution is preferentially carried out; an elemental effect calculation section for calculating an energy effect of every energy saving solution for a base of interest among the bases where the energy saving solution is preferentially carried out in the priority order, with reference to a data base storing equipment information before installing the energy saving equipment for the base of interest and a data base storing specifications of the energy saving equipment for the base of interest, and this calculation of the energy saving effect of every energy saving solution being carried out for every base of the bases where the energy saving solution is preferentially carried out in the priority order, and outputting the calculated energy saving effect of every energy saving solution for every base in a form of an elemental effect table; a consolidation section for creating the energy saving plan in accordance with the users need, using the elemental effect table, and representing this energy saving plan to the user; and for every action year, the consolidation section adopts an energy saving solution set in the elemental effect table as the energy saving solution to be introduced in an action year of interest in the priority order of base selection for the energy saving solution, so that total energy saving effect due to the adopted energy saving solution can clear a target reduction to be achieved in a next year after a year when the energy saving solution is carried out, and represents to the user an energy saving plan that specifies an energy saving equipment to be installed and a year when to install the equipment.

(2) In (1), the present invention may employ a configuration in which the user setting section has a function for setting an estimated budget for every year as the users need, and although the total energy saving effects due to the adopted energy saving solutions clear the target reduction to be achieved in the next year after the year when the energy saving solution is carried out, but if total installation cost of the energy saving equipment installed is less than a total estimated budget for every year up to the action year the consolidation section installs an additional energy saving solution in the action year of interest in a range in which the total installation cost of the energy saving equipment installed does not exceed the total estimated budget for every year up to the action year of interest.

(3) In (2), the present invention may employ a configuration in which, if the total installation cost of the energy saving equipment installed is more than the total estimated budget for every year up to the action year of interest, the consolidation section defines a year when to install the energy saving equipment so that the total energy saving effect due to the adopted energy saving solutions barely clear the target reduction to be achieved in the next year of the action year of interest.

(4) In (1), the present invention may employ a configuration in which the consolidation section defines a year when to install the energy saving equipment so that the total energy saving effect due to the adopted energy saving solutions barely clears the target reduction to be achieved in the next year of the action year of interest.

(5) In any one of (1) to (4), the present invention may employ a configuration in which the user setting section has a function for setting a priority order of selecting the energy saving equipment to be preferentially installed from plural energy saving equipments, and setting a priority order of conditions to define which of a priority order of selecting a base where the energy saving solution is preferentially carried out or the priority order of selecting the energy saving equipment to be preferentially installed is given a higher priority, for every action year, the consolidation section adopts the energy saving solution in the elemental effect table as the energy saving solution to be installed in the next year after the action year of interest in an order that satisfies the priority order of selecting the base where the saving energy solution is preferentially carried out, the priority order of selecting the energy saving solution to be preferentially carried out and the priority order of the conditions, so that the total energy saving effect due to the adopted energy saving solution clears the target reduction to be achieved in the next year after the action year of interest, and represents to a user the energy saving plan to define the energy saving equipment for the every base of the bases where the energy saving solution is preferentially carried out and the year when to install the energy saving equipments.

(6) In any one of (1) to (5), the present invention may employ a configuration in which the consolidation section sums up energy consumptions after the energy saving solutions are carried out for the every base, and outputs the summation of the energy consumptions along with target values as a transit of an energy consumption through all the plural bases.

(7) In any one of (1) to (6), the present invention may employ a configuration in which the consolidation section converts at least one of the energy saving effect for every energy saving solution in the elemental effect table and the target reduction of the energy consumption through all the plural bases for every year, so as to compare both the energy saving effect for every energy saving solution and the target reduction for every year with each other.

(8) In any one of (1) to (7), the present invention may employ a configuration in which quantity in crude oil equivalent or CO₂ emission is used as an index of the energy consumption.

(9) In any one of (1) to (8), the present invention may employ a configuration in which reduction rate is used as the target reduction for every year.

(10) In any one of (1) to (9), the present invention may employ a configuration in which the computer includes a server computer and a client computer, which are coupled with each other via a network, an input of the users need on the user setting section is executed on the client computer, the energy saving effect is calculated on the elemental effect calculation section, and the year when to install the energy saving equipment is defined on the server computer.

(11) In any one of (1) to (9), the present invention may employ a configuration in which both the calculation of the energy saving effect and the definition of the year when to install the energy saving equipment are executed on a single computer.

(12) The present invention provides an energy saving assistance program that runs on at least one computer, and creates an energy saving plan for defining time when to introduce an energy saving action implemented by installing energy saving equipment. The program includes an elemental effect calculation section for calculating an energy effect of every energy saving solution for a base of interest among the bases where the energy saving solution is preferentially carried out in the priority order, with reference to a data base storing equipment information before installing the energy saving equipment for the base of interest and a data base storing specifications of the energy saving equipment for the base of interest, and this calculation of the energy saving effect of every energy saving solution being carried out for every base of the bases where the energy saving solution is preferentially carried out in the priority order, and outputting the calculated energy saving effect of every energy saving solution for every base in a form of an elemental effect table; a user setting section for setting as users need a target reduction of energy consumption through all of plural bases for every year and a priority order of selecting from the plural bases a base where an energy saving solution is preferentially carried out; a consolidation section for creating the energy saving plan in accordance with the users need, using the elemental effect table, and representing this energy saving plan to the user; and for every action year, the consolidation section adopts an energy saving solution set in the elemental effect table as the energy saving solution to be introduced in an action year of interest in the priority order of base selection for the energy saving solution, so that total energy saving effect due to the adopted energy saving solution can clear a target reduction to be achieved in a next year after a year when the energy saving solution is carried out, and represents to the user an energy saving plan that specifies an energy saving equipment to be installed and a year when to install the equipment.

Other features and advantages of the present invention will become more apparent from the following detailed description of the invention when taken in conjunction with the accompanying exemplary drawings.

### BRIEF DESCRIPTION OF THE DRAWINGS

FIG. 1 shows a hardware configuration for realizing the present invention.

FIG. 2 is a functional block diagram for embodying the present invention.

FIG. 3 is a functional block diagram showing each of elemental effect calculation sections.

FIG. 4 is a functional block diagram of a consolidation section.

FIG. 5 shows an example of a monitoring display of a base information input section.

FIG. 6 shows an example of a monitoring display of a user setting section.

FIG. 7A shows a table format of a table stored in an energy saving DB.

FIG. 7B shows a table format of a table stored in an energy saving DB.

FIG. 7C shows a table format of a table stored in an energy saving DB.

FIG. 7D shows a table format of a table stored in an energy saving DB.

FIG. 7E shows a table format of a table stored in an energy saving DB.

FIG. 8 is a flow chart of an elemental effect calculation function unit.

FIG. 9A shows a table format for output data output from the elemental effect calculation function unit.

FIG. 9B shows a table format for output data output from the elemental effect calculation function unit.

FIG. 10 is a flow chart of a reduction rate calculation function unit.

FIG. 11 shows a format of a table stored in an effect DB.

FIG. 12 is a flow chart of a solution selection function unit.

FIG. 13 shows a table format of a table stored in a solution DB.

FIG. 14 is a flow chart of a planning function unit.

FIG. 15 is a detailed flow chart of a “Definition of Energy Saving Action Year” step of FIG. 14.

FIG. 16 shows a table format of an output table of the “Definition of Energy Saving Action Year” step of FIG. 14.

FIG. 17 shows an example of a list of energy saving solutions for each base, which is outputted by the present invention.

FIG. 18 is a detailed flow chart of an “Outputting Total Energy Saving Effect” step of FIG. 14.

FIG. 19 is a table format of an output table at an “Outputting Total Energy Saving Effect” step of FIG. 14.

FIG. 20 is a graph showing an estimation of the total energy saving effect output by the present invention.

### DETAILED DESCRIPTION OF THE PREFERRED EMBODIMENTS

Descriptions will be provided on the present invention with reference to the drawings, hereinafter. Note that, in each drawing and each embodiment, the same numerical references are used for components having the similar or same functions, and detailed descriptions will be omitted.

Hereinafter, descriptions will be provided on an embodiment of the present invention.

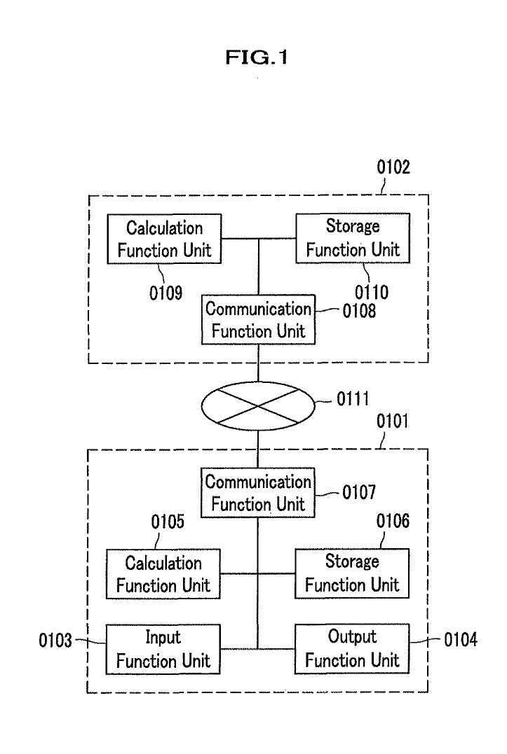

FIG. 1 shows a hardware configuration for realizing the present invention. The present invention is embodied by at least one computer and a program that runs on the computer. Herein, the hardware configuration is exemplified in an ASP (Application Service Provider) model including a client 0101 and a server 0102. First, various function units of the client 0101 will be described. A numeric reference 0103 denotes an input function unit for inputting a user's will, such as a keyboard, a mouse, a touch panel, etc. A numeric reference 0104 denotes an output function unit for informing a user of a calculated result, such as a monitor or printer. A numeric reference 0105 denotes a calculation function unit, which may be a processor such as a CPU. A numeric reference 0106 denotes a storage function unit for temporarily storing data in a semiconductor memory or the like. A numeric reference 0107 is a communication function unit for the client 0101 to communicate data with another computer. In the client 0101, the input function unit 0103, the output function unit 0104, the calculation function unit 0105, the storage function unit 0106 and the communication function unit 0107 are electrically coupled with one another.

Next, various function units of the server 0102 will be described hereinafter. A numeric reference 0108 denotes a communication function unit for the server 0102 to communicate data with another computer. A numeric reference 0109 denotes a calculation function unit that is a processor such as a CPU. A numeric reference 0110 is a storage function unit for temporarily storing data in the semiconductor memory or the like. In the server 0102, the communication function unit 0108, the calculation function unit 0109, the storage function unit 0110 are electrically coupled with one another. A numeric reference 0111 denotes a communication network such as the Internet, and the client 0101 and the server 0102 are coupled with each other through the communication network 0111.

The order of processing for embodying the present invention in the above configuration is as follow:

(Process 1) Inputting data into the input function unit 0103 by a user.

(Process 2) Transmitting input data from the communication function unit 0107 to the communication function unit 0108.

(Process 3) Using the storage function unit 0110 when necessary so as to create an energy saving plan on the calculation function unit 0109.

(Process 4) Transmitting the energy saving plan from the communication function unit 0108 to the communication function unit 0107.

(Process 5) Outputting the energy saving plan from the output function unit 0104.

The present invention may be embodied on the client alone (a single computer alone). In this case, the order of processing for embodying the energy saving plan is as follow:

(Process 1) Inputting data into the input function unit 0103 by a user.

(Process 2) Using the storage function unit 0106 when necessary so as to create an energy saving plan on the calculation function unit 0105.

(Process 3) Outputting the energy saving plan from the output function unit 0104.

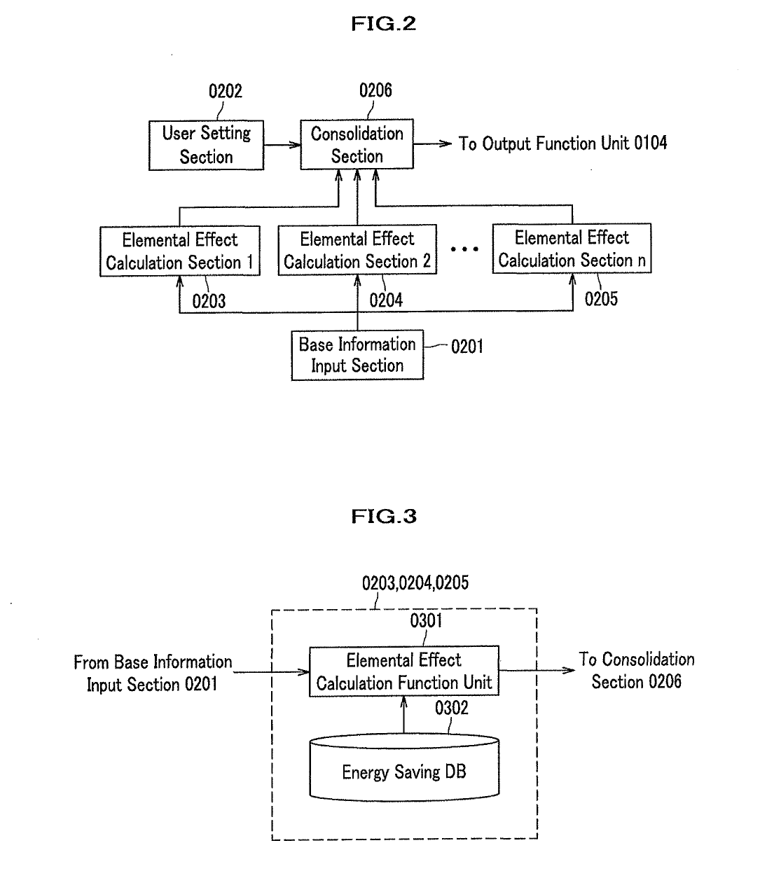

FIG. 2 is a functional block diagram for embodying the present invention. A numeric reference 0201 denotes a base information input section that is an input function unit for inputting equipment information and energy information of a base of interest where an energy saving solution is carried out. A numeric reference 0202 denotes a user setting section that is an input function for inputting user's will, such as setting of a priority order of selecting a base where an energy saving solution preferentially carried out, setting of a priority order of selecting which energy saving solution should be preferentially carried out in the selected base or a budget estimation for the selected base, etc. The base information input section 0201 and the user setting section 0202 correspond to the input function unit 0103 of the client 0101 in FIG. 1, where a user inputs various data.

Next, numeric references 0203, 0204, 0205 denote respective elemental effect calculation sections, each of which is a calculation function for calculating an effect of energy saving for each equipment (each energy saving solution). In FIG. 2, one elemental effect calculation section is represented in a block for one base. For example, the elemental effect calculation sections are represented in respective blocks in such a manner that the elemental effect calculation section 0203 calculates an effect of energy saving for the base A, and the elemental effect calculation section 0204 calculates an effect of energy saving for the base B.

A numeric reference 0206 denotes a consolidation section having an output function for outputting effects of energy saving calculated on the elemental effect calculation sections 0203, 0204, 0205 and a list of energy saving solutions for each base in accordance with the user's setting on the user setting section 0202. In case of embodying the present invention in the ASP model, the elemental effect calculation sections 0203, 0204, 0205 and the consolidation section 0206 are incorporated in the calculation function unit 0109 of the server 0102 of FIG. 1. On the other hand, in case of the “stand-alone” model, in which the present invention is embodied on the client 0101 alone, the elemental effect calculation sections 0203, 0204, 0205 and the consolidation section 0206 are incorporated in the calculation function unit 0105 of the client 0101 of FIG. 1.

FIG. 3 is a functional block diagram showing each of the elemental effect calculation sections 0203, 0204, 2050. The same process is carried out on each of the elemental effect calculation sections 0203, 0204, 2050. A numeric reference 0301 denotes an elemental effect calculation function unit for calculating an effect of energy saving for each energy saving solution and transmitting the calculated result to the consolidation section 0206. A numeric reference 0301 denotes a energy saving DB, which stores various data used by the elemental effect calculation function unit 0301 to calculate an effect of energy saving.

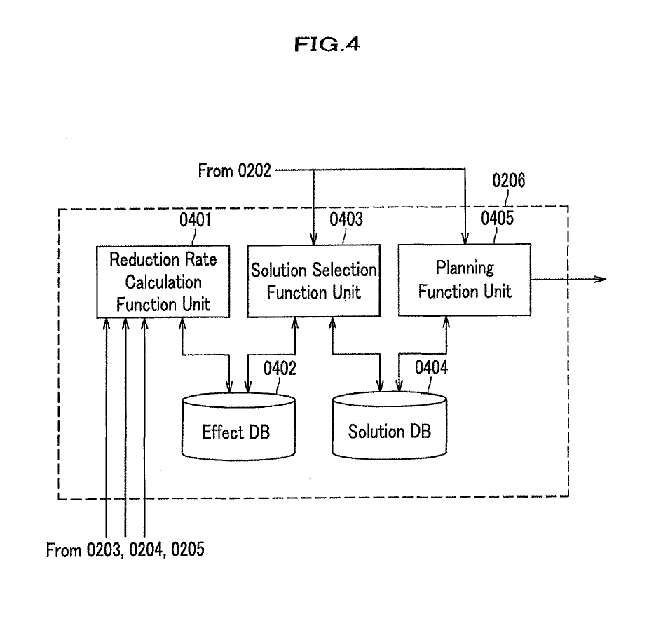

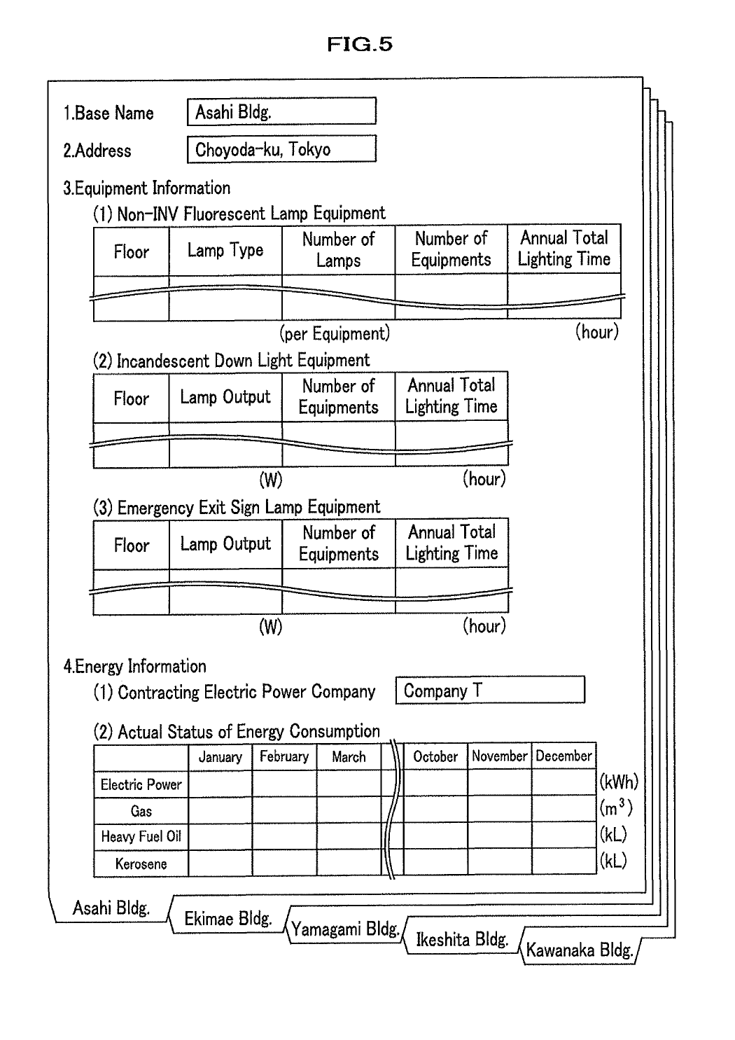

FIG. 4 is a functional block diagram of the consolidation section 0206. A numeric reference 0401 denotes a reduction rate calculation function unit for converting individual effects of energy saving calculated for every base on the elemental effect calculation sections 0203, 0204, 0205 into an energy saving rate relative to a total energy consumption through all the bases, and storing the converted result on the effect DB (database) 0402. The effect DB 0402 has a function for storing effect of energy saving for each base. A numeric reference 0403 denotes a solution selection function unit, which extracts appropriate data from the effect DB 0402 based on the users need set on the user setting section 0202 such as setting of the priority order of selecting a base where an energy saving solution should be preferentially carried out, and stores the extracted data in the solution DB (database) 0404. The solution DB 0404 has a function for storing an energy saving solution selected based on the users need. The effect DB 0402 and the solution DB 0404 are included in the storage function unit 0110 of the server 0102 or the storage function unit 0106 of the client 0101.

A numeric reference 0405 denotes a planning function unit which, based on the annual reduction rate set on the user setting section 0202 and data stored on the solution DB 0404, selects an energy saving solution for each base and calculates an estimation of total energy consumption through all the bases after the energy saving solution is carried out relative to an estimation value of energy saving for every year.

Detailed descriptions will be provided on the embodiment of the present invention, using examples of this embodiment hereinafter.

FIG. 5 shows an example of a monitoring display of the base information input section 0201. Data input on this input section 0201 is sent to the elemental effect calculation sections 0203, 0204, 0205. Input items are 1. Base Name, 2. Address, 3. Equipment Information, 4. Energy Information, and these items are set for each base. This example of the embodiment exemplifies that there are five bases on each of which an energy saving solution is carried out, and the name of these bases are “Asahi Bldg”, “Ekimae Bldg.”, “Yamagami Bldg.”, “Ikeshita Bldg.”, and “Kawanaka Bldg.” (these all are three-story buildings).

A name of a base of interest is input in 1. Base Name. An address of a base of interest is input in 2. Address.

In this example, 3. Equipment Information includes sub-items of the number of (1) Non-inverter (“inverter” is referred to as “INV” hereinafter) Fluorescent Lamp Equipment, the number of (2) Incandescent Down Light Equipment and the number of (3) Emergency Exit Sign Lamp Equipment (Using Fluorescent Lamp), and various actual statuses at the time of creating an energy saving plan are input in each sub-item. In the table of (1) Non-INV Fluorescent Lamp Equipment, the number of equipments and the annual total lighting time are input in each field of “Floor”, “Lamp Type” and “Number of Lamps” per lighting equipment. In the table of (2) Number of Incandescent Down Lights, the number of equipments and the annual total lighting time are input for each field of “Floor” and “Lamp Output”. In the table of (3) Number of Emergency Exit Sign Lamp Equipment, the number of equipments and the annual total lighting time are input for each field of “Floor” and “Lamp Output”.

4. Energy Information includes sub-items of (1) Contracting Electric Power Company and (2) Actual Status of Energy Consumption, and data is input in each sub-item as follow. (1) A name of a contracting electric power company with which power purchase agreement is made is input in (1) Contracting Electric Power Company. (2) An actual status of energy consumption of electric power, gas, heavy fuel oil, kerosene are input in (2) Actual Status of Energy Consumption per month of the past year.

In the base information input section 0201, a tab at the bottom edge of the screen is switched to select a base of interest where to input data, so as to input various data of the above times for each base.

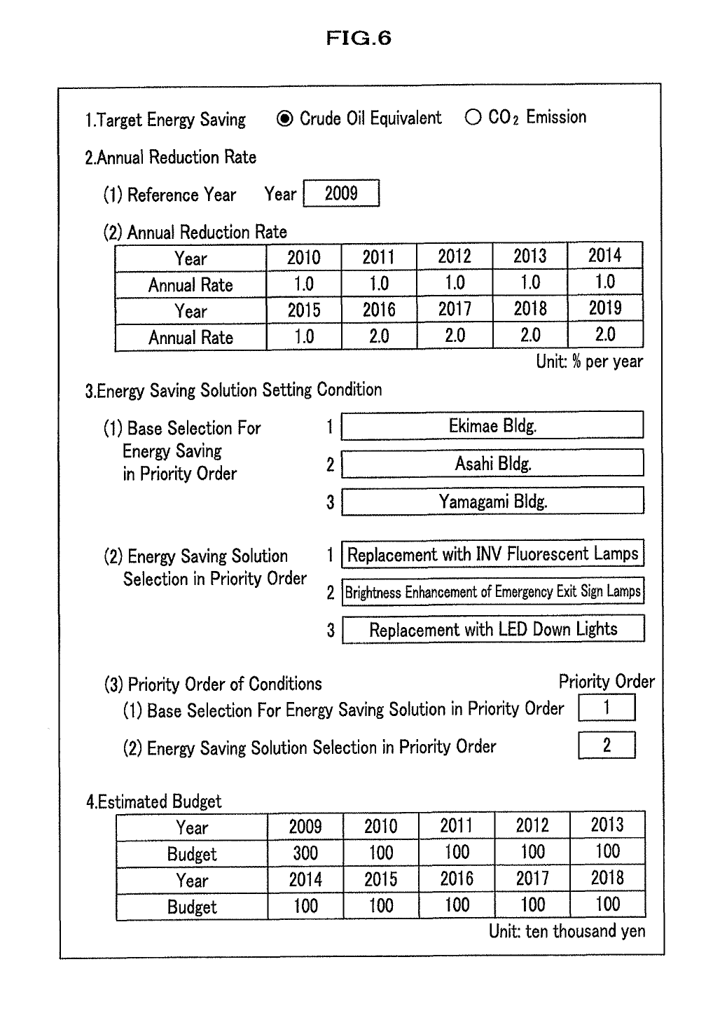

FIG. 6 shows an example of a monitoring display of the user setting section 0202. In this example, input items are 1. Target Energy Saving, 2. Annual Reduction Rate, 3. Energy Saving Solution Setting Condition and 4. Estimated Budget, for example.

In the input item of 1. Target Energy Saving, an evaluation index of an effect of energy saving is selected. In this example, either “Crude Oil Equivalent” or “CO₂ Emission” may be selected. “Crude Oil Equivalent” denotes equivalent quantity of crude oil consumption for energy consumption such as electric power base. On the other hand, “CO₂ Emission” denotes a CO₂ emission due to energy consumption such as electric power. In this example, “Crude Oil Equivalent” is chosen as the evaluation index representing an effect of energy saving, for example.

In 2. Annual Reduction Rate, data is input in sub-items of (1) Reference Year and (2) Annual Reduction Rate. (1) Reference Year denotes the first year when an energy saving plan is created, and corresponds to the year for which data is input in 4. (2) Actual Status of Energy Consumption of FIG. 5. In this example, “2009” is set in (1) Reference Year. In the present invention, the “Reference Year” may start with “April” or “January”, and in this example, the “Reference Year” starts with January for the sake of simplifying the explanation. In the sub-item of (2) Annual Reduction Rate, an annual reduction rate per year is input for ten years from the reference year of 2009. In this example, setting in (2) is such that “the energy saving plan to reduce the energy consumption in crude oil equivalent at an annual rate of 1.0% from the reference year 2009 to the year 2015 and at an annual rate of 2.0% from the year 2016 or later is output”. The annual reduction rate may be preset in the program of the present invention in advance.

In 3. Energy Saving Solution Setting Condition, setting is carried out in (1) Base Selection For Energy Saving Action in Priority Order, (2) Energy Saving Solution Selection in Priority Order and (3) Priority Order of Conditions. In (1) Base Selection For Energy Saving Solution in Priority Order, names of the bases where an energy saving solution is carried out in the priority order are input if the users need desires that a energy saving solution be preferentially carried out for particular bases, such as energy saving model buildings.

In this example, three bases may be set in the priority order of “Ekimae Bldg.”, “Asahi Bldg.” and then “Yamagami Bldg”, for example. In the sub-item of (2) Energy Saving Solution Selection in Priority Order, names of the energy saving solutions are set if the users need desires the priority order in selecting energy saving solutions (such as energy saving equipment and device). In this example, three types of energy saving solutions are set in the priority order of the “Replacement with INV fluorescent lamps”, the “Brightness Enhancement of Emergency Exit Sign Lamps” and the “Replacement with LED Down Lights”, for example. In (3) Priority Order Of Conditions, setting is made to define which of the (1) Base Selection For Energy Saving Action in Priority Order and the (2) Energy Saving Solution Selection in Priority Order is preferentially carried out. This example illustrates that priority is given first on the (1) Base Selection For Energy Saving Solution in Priority Order, and second on the (2) Energy Saving Solution Selection in Priority Order. According to the above settings, the energy saving plan is created in the following action priority order:
Action Priority 1: Ekimae Bldg.—replacement with INV fluorescent lamps
Action Priority 2: Ekimae Bldg.—brightness enhancement of emergency exit sign lamps
Action Priority 3: Ekimae Bldg.—replacement with LED down lights
Action Priority 4: Asahi Bldg.—replacement with INV fluorescent lamps
Action Priority 5: Asahi Bldg.—brightness enhancement of emergency exit sign lamps
Action Priority 6: Asahi Bldg.—replacement with LED down lights
Action Priority 7: Yamagami Bldg.—replacement with INV fluorescent lamps
Action Priority 8: Yamagami Bldg.—brightness enhancement of emergency exit sign lamps
Action Priority 9: Yamagami Bldg.—replacement with LED down lights

If estimated budget for an energy saving solution is known, this estimated budget is input in 4. Estimated Budget. This example exemplifies that the estimated budget is three million yen for the year 2009, and one million yen per year after 2009. Note that estimated budget should be set in one year before a year when an annual reduction rate is calculated; therefore, the year period for setting estimated budgets is ten years, staring with the year 2009 that is one year before the reference year 2010.

Descriptions hereinafter will be provided on processes of the elemental effect calculation section 0203, 0204, 0205, and then on processes of the consolidation section 0206.

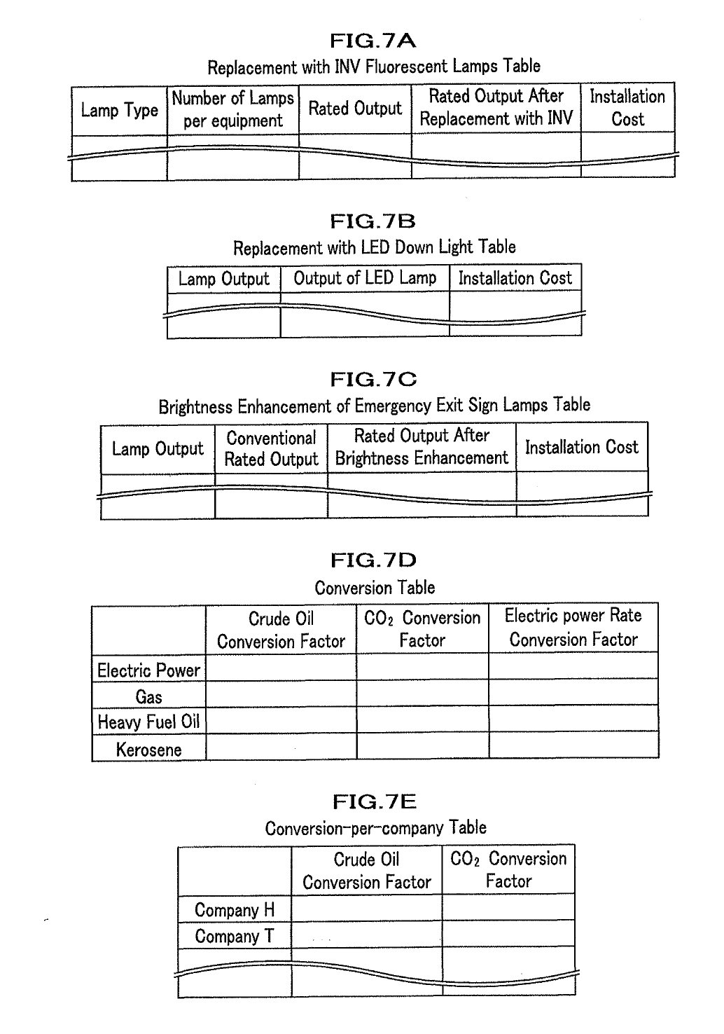

FIGS. 7A to 7E show the formats of various tables stored in each energy saving DB 0302 included in the elemental effect calculation sections 0203, 0204, 0205, respectively. The energy saving DB 0302 is a database storing information regarding specifications of energy saving equipment and devices. This energy saving DB 0302 includes information for calculating an effect of a certain energy saving equipment or device if this equipment is installed (rated output thereof after installation, for example).

FIG. 7A shows a “Replacement with INV Fluorescent Lamp Table”, in which a rated output (W) (before replacement with INV), a rated output (W) after replacement with INV and installation cost of INV fluorescent lamp equipment (yen) are stored for each lamp type and the number of lamps per lamp equipment or device.

FIG. 7B shows a “Replacement with LED Down Light Table”, in which an output of LED lamp (W) to be installed and a lamp installation cost (yen) are stored for each output of incandescent lamp (W).

FIG. 7C shows the “Brightness Enhancement of Emergency Exit Sign Lamp Table”, in which a rated output (W) per conventional emergency exit sign lamp equipment, a rated output (W) after the brightness enhancement, and an installation cost (yen) per emergency exit sign lamp equipment are stored for each output (W) of the emergency exit sign fluorescent lamp.

FIG. 7D shows the “Conversion Table”, in which factors used for calculating a consumption in crude oil equivalent, CO₂ emission and electric power rate based on each consumption of various types of energy (such as electric power, gas, heavy fuel oil, kerosene) are recoded. A unit of each factor is as follow: (represented in order of a crude oil conversion factor, a CO₂ conversion factor and an electric power rate conversion factor for each energy type)
Electric power: kL/kWh, kg-Co₂/kWh, ¥/kWh
Gas: kL/m³, kg-Co₂/m³, ¥/m³
Heavy fuel oil: kL/kL, kg-CO₂/kL, ¥/kL
Kerosene: kL/kL, kg-CO₂/kL, ¥/kL

Factors for converting electric power (kWh) into crude oil consumption and CO₂ emission rely on the facilities of an electric power company such as a percentage of atomic power generation; therefore, values available from (e) the “Conversion-per-company Table” may be used in place of such factors.

FIG. 7E shows the “Conversion-per-company Table”, in which a crude oil conversion factor and CO₂ emission per kWh for each electric power company.

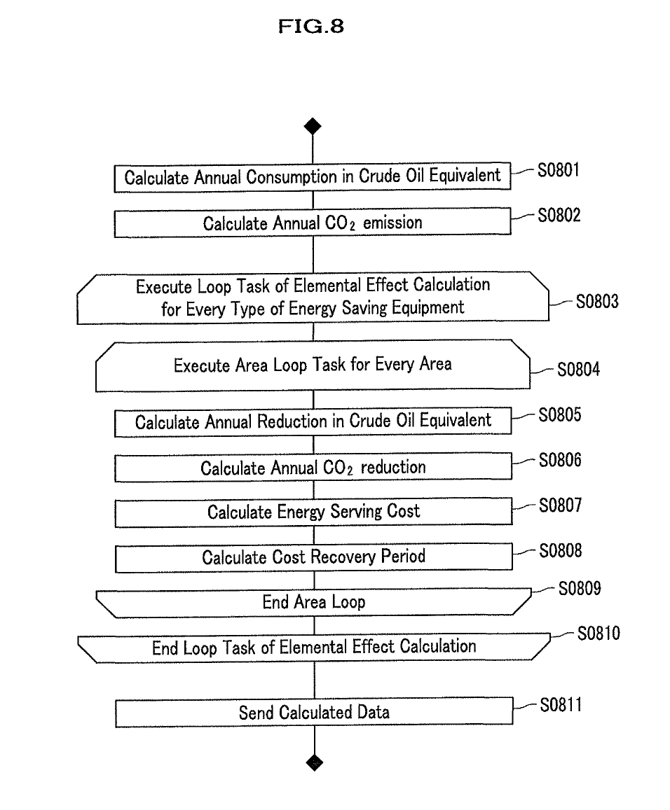

FIG. 8 is a flow chart of the elemental effect calculation function unit 0301. In this example, descriptions will be provided on processes of the elemental effect calculation function unit 0301 by exemplifying a case in which an elemental effect for the “Asahi Bldg.” is calculated, for example.

At S0801, consumption in crude oil equivalent that is equivalent to an annual energy consumption in a base of interest is calculated.

Among information regarding various buildings, input in the base information input section 0201 as shown in FIG. 5, “Asahi Bldg.” is selected. Using input data of (2) Actual Status of Energy Consumption of 4. Energy Information, a crude oil conversion function of the (d) Conversion Table and data of the (e) Conversion-per-company Table if necessary, the annual consumption in crude oil equivalent (unit: kL) is calculated by use of Formula (1).

$$Annual consumption in crude oil equivalent = Annual summation of electric power consumptions \times crude oil conversion factor from electric power into crude oil + Annual summation of gas consumptions \times crude oil conversion factor from gas into crude oil + Annual summation of heavy fuel oil consumptions \times crude oil conversion factor from heavy fuel oil into crude oil + Annual summation of kerosene consumptions \times crude oil conversion factor from kerosene into crude oil \qquad Formula ( 1 )$$

In this case, each of the above annual summation is obtained by summing up actual statuses of energy consumption from January to December.

The calculated annual consumption in crude oil equivalent is temporarily stored in the storage function unit 0110 (in case of the ASP model) or in the storage function unit 0106 (in case of the stand-alone model).

At S0802, CO₂ emission caused due to the annual energy consumption of a base of interest is calculated. As similar to the case at S0801, “Asahi Bldg.” is selected among the information regarding various buildings input in the base information input section 0201. Using input data of (2) Current status of energy consumption of 4. Energy Information, a crude oil conversion function of the (d) Conversion Table, and data of the (e) Conversion-per-company Table if necessary, the annual CO₂ emission (unit: kg-CO₂) is calculated by use of Formula (2).

$$Annual {CO}_{2} emission = Annual summation of electric power consumptions \times {CO}_{2} conversion factor from electric power into {CO}_{2} + Annual summation of gas consumptions \times {CO}_{2} conversion factor from gas into {CO}_{2} + Annual summation of heavy fuel oil consumptions \times {CO}_{2} conversion factor from heavy fuel oil into {CO}_{2} + Annual summation of kerosene consumptions \times {CO}_{2} conversion factor from kerosene into {CO}_{2} \qquad Formula ( 2 )$$

The calculated annual CO₂ emission is temporarily stored in the storage function unit 0110 (in case of the ASP model) or in the storage function unit 0106 (in case of the stand-alone model).

At S0803, a loop task of an elemental effect calculation is executed in turns for every type of the energy saving equipment. In this example, in (2) Priority Order of Energy Saving Solution Selection of 3. Energy Saving Solution Setting Condition as shown in FIG. 6, “Replacement with INV Fluorescent Lamps”, “Brightness Enhancement of Emergency Exit Sign Lamp” and “Replacement with LED Down Lights” are set, thus the above loop task is executed in turns for these three types of energy saving solutions. Note that this loop task starts at S0803 and ends at S0809, and is executed in turns for every type of the energy saving solutions from S0804 to S0809.

At S0804, an area loop task is executed for every area of a building of interest (“Asahi Bldg.” in this case), so that the loop task is executed for every floor from the first floor to the third floor of the three-story “Asahi Bldg.”. Note that this loop task starts at S0805 and ends at S0810, and this loop task is executed for each floor in turn from S0805 to S0808.

At S0805, an energy saving effect due to an energy saving solution is calculated in terms of crude oil quantity by use of Formula (3) so as to calculate the annual reduction in crude oil equivalent (unit: kL).

Annual reduction in crude oil equivalent=(Δrated output/1000)×annual total lighting time×the number of equipments×crude oil conversion factor from power supply into crude oil Formula (3)

The Δ rated output (unit: W) denotes a difference in rated output of an energy saving equipment between before and after an energy saving solution is carried out. In the case of “Replacement with INV Fluorescent Lamps”, based on the data in the table of FIG. 7A,

ΔRated output=rated output−rated output after replacement with INV fluorescent lamps Formula (4).

Similarly, in the case of “Replacement with LED Down Lights”, based on the data in the table of FIG. 7B,

ΔRated output=lamp output−LED lamp output Formula (5)

Furthermore, similarly in the case of “Brightness Enhancement of Emergency Exit Sign lamp”, based on the data in the table of FIG. 7C,

ΔRated output=conventional rated output−high-brightness type rated output Formula (6).

As for the annual total lighting time and the number of equipments, respective values for a floor of interest input in 3. Equipment Information for a building of interest in FIG. 5 (“Asahi Bldg.” in this case) are used.

At S0806, the annual CO₂ reduction (unit: kg-COO due to an energy saving solution is calculated by use of Formula (7).

Annual CO₂Reduction=(Δrated output/1000)×annual total lighting time×the number of equipments×CO₂ conversion factor from electric power supply into CO₂ Formula (7)

where, Δ rated electric power is the same as that at S0805.

At S0807, using Formula (8), an installation cost for installing a new equipment or device due to an energy serving solution is calculated as an energy serving cost (unit; yen).

Energy serving cost=the number of equipments for replacement×installation cost Formula (8)

wherein, as for the number of equipments for replacement, concerned values in 3. Equipment Information for a building of interest of FIG. 5 (“Asahi Bldg.” in this case) are used. As for the installation cost, concerned values of the tables of FIGS. 7A, 7B and 7C are used.

At S0808, a cost recovery period for an installation cost is calculated based on the cost reduction of electric power rate due to an energy saving solution, using Formula (9).

$$Cost recovery period = Energy saving cost / annual cost reduction due to energy saving solution = Energy saving cost / ( ( Δ rated output / 1000 ) \times annual total lighting time \times the number of equipments \times electric power rate conversion factor from electric power supply into electric power rate ) . \qquad Formula ( 9 )$$

Note that the Δ rated electric power, the annual total lighting time and the number of equipments herein are the same as those in the above descriptions. As for the electric power rate conversion factor from electric power supply into electric power rate, a value in the “Conversion Table” of FIG. 7D is used.

As explained above, steps of S0805, S0806. S0807 and S0808 are repeatedly executed with the area loop task (from S0804 to S0809) and the elemental effect calculation loop task (from S0803 to S0810), so as to calculate an energy saving effect due to an energy saving solution on each floor. In FIGS. 7A to 7E and FIG. 8, descriptions are given by exemplifying an energy saving solution concerning electric power supply, but the same technical idea may also be applicable to a case of an energy saving solution concerning gas, heavy fuel oil or kerosene, and each of the above formulas may be used when necessary.

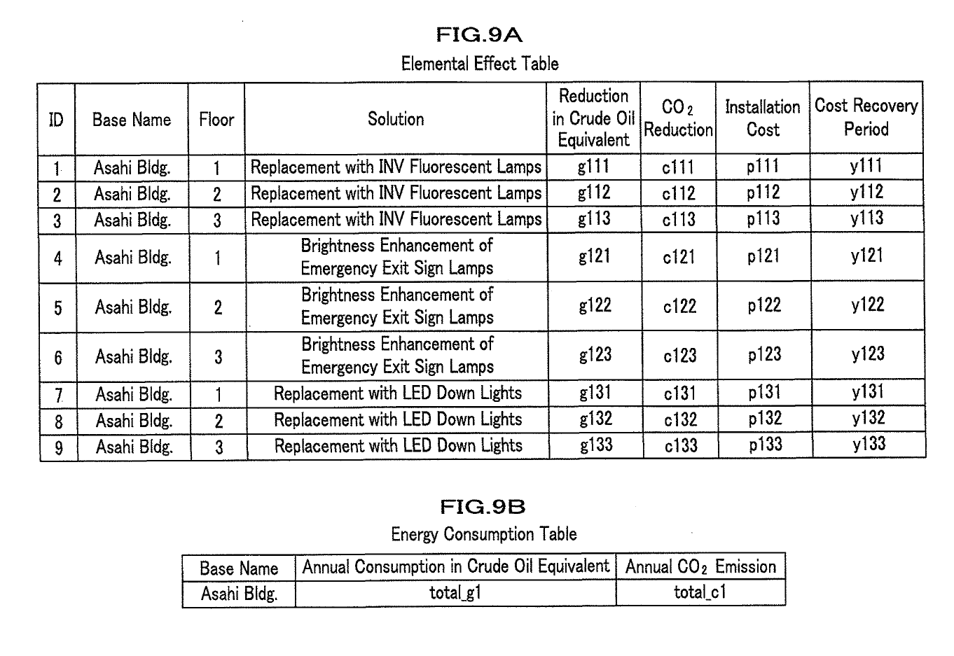

At S0811, the above calculated data are recorded in table formats, and send them to the consolidation section 0206. The table formats will be described with reference to FIGS. 9A and 9B hereinafter.

FIGS. 9A and 9B show table formats of output data output from the elemental effect calculation function unit 0301. 9A shows a table format of an elemental effect table, whose elements are “ID”, “Base Name”, “Floor”, “Solution”, “Reduction in Crude Oil Equivalent”, “CO₂ Reduction”, “Installation Cost” and “Cost Recovery Period”. “ID” is set by starting with the number “1”. “Base Name” indicates a base name of interest, which is targeted by the elemental effect calculation function unit 0301 (“Asahi Bldg.” herein). “Floor” indicates a floor of interest where the area loop is executed at S0804. “Solution” indicates a name of an energy saving solution of interest, for which the elemental effect calculation loop is executed at S0803. “Reduction in Crude Oil Equivalent” indicates an annual reduction in crude oil equivalent calculated at S0805. “CO₂ Reduction” indicates an annual CO₂ reduction calculated at S0806. “Installation Cost” indicates a cost for an energy saving solution calculated at S0807. “Cost Recovery Period” indicates a cost recovery period calculated at S0808. The Asahi Bldg. has three floors and three types of energy saving solutions are carried out for this base, so that the number of the floors×three types of energy saving solutions yields nine records to be stored.

FIG. 9B shows a table format of an energy consumption table, whose elements are “Base Name”, “Annual Consumption in Crude Oil Equivalent”, “Annual CO₂ Emission”. “Base Name” indicates a base name (“Asahi Bldg. in this case) targeted by the elemental effect calculation function unit 0301”. The “Annual Consumption in Crude Oil Equivalent” indicates a value calculated at S0801. The “Annual CO₂ Emission” is a value calculated at S0802. Both the values calculated at S 0801 and S0802 are respective annual summations of “Annual Consumption in Crude Oil Equivalent” and “Annual CO₂ Emission” in a base of interest.

The tables of FIGS. 9A and 9B are created in five sets for five bases in this example of the present embodiment since these tables are output from each of the elemental effect calculation sections 0203, 0204 and 0205 or the like for all bases input in the base information input section 0201 as explained in FIG. 5.

The processes of the consolidation section 0206 will be described hereinafter.

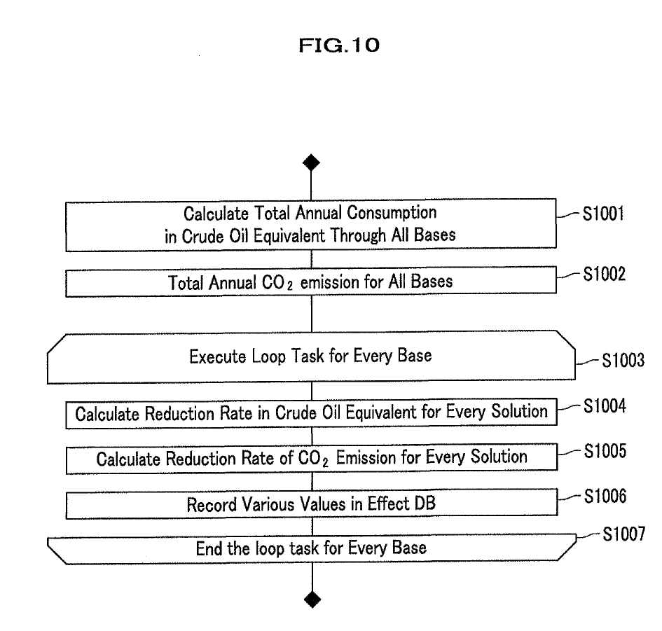

FIG. 10 is a flow chart of the reduction rate calculation function unit 0401. This function unit converts individual annual reductions in crude oil equivalent and CO₂ reductions for all the bases (“Asahi Bldg.”, “Ekimae Bldg.”, “Yamagami Bldg.”, “Ikeshita Bldg.” and “Kawanaka Bldg.” in this case) calculated in the elemental effect calculation sections 0203, 0204 and 0205 respectively into a reduction rate relative to a total energy consumption through all the bases, and the converted result is stored in the effect DB 0402.

Note that the operation at this step has an object to provide a format that enables comparison of individual energy saving effects calculated at the elemental effect calculation sections 0203, 0204 and 0205 with a target reduction concerning the total energy consumption through all the bases for every year (the annual reduction rate in this example of the embodiment). Therefore, a target reduction for every year (the annual reduction rate) may be converted instead of converting the individual energy saving effects calculated in the elemental effect calculation sections 0203, 0204 and 0205, or both may be converted. Alternatively, this conversion step may be omitted in a case in which users need is not specified by an annual reduction rate but is specified by a manner that allows a direct comparison between this users need and the individual energy saving effects calculated in the elemental effect calculation sections 0203, 0204 and 0205, without using the above conversion.

At S1001, individual annual consumptions in crude oil equivalent calculated for all the bases (“Annual Consumption in Crude Oil Equivalent” of the table of FIG. 9B) are summed up so as to calculate a total annual consumption in crude oil equivalent through all the bases. The total annual consumption in crude oil equivalent through all the bases (unit: kL) is calculated using Formula (10).

$$Total annual consumption in crude oil equivalent through all the bases = Summation of individual annual consumptions in crude oil equivalent for every base = total\_g 1 + total\_g 2 + total\_g 3 + total\_g 4 + total\_g 5 \qquad Formula ( 10 )$$

where,

total_g1: annual consumption in crude oil equivalent of Asahi Bldg.

total_g2: annual consumption in crude oil equivalent of Ekimae Bldg.

total_g3: annual consumption in crude oil equivalent of Yamagami Bldg.

total_g4: annual consumption in crude oil equivalent of Ikeshita Bldg.

total_g5: annual consumption in crude oil equivalent of Kawanaka Bldg.

At S1002, individual annual CO₂ emissions calculated for every base (“Annual CO₂ Emission” of FIG. 9B) are summed up so as to calculate a total annual CO₂ emission through all the bases. The total annual CO₂ emission through all the bases (unit: kg-COO is calculated using Formula (11).

$$Total annual {CO}_{2} emission for all the bases = Summation of individual annual {CO}_{2} emissions for every base = total\_c 1 + total\_c2 + total\_c 3 + total\_c 4 + total\_c 5 \qquad Formula ( 11 )$$

where,

total_c1: annual CO₂ emission of Asahi Bldg.

total_c2: annual CO₂ emission of Ekimae Bldg.

total_c3: annual CO₂ emission of Yamagami Bldg.

total_c4: annual CO₂ emission of Ikeshita Bldg.

total_c5: annual CO₂ emission of Kawanaka Bldg.

At S1003, a loop task is carried out for every base. In this example, the loop task is carried out for the five bases: “Asahi Bldg.”, “Ekimae Bldg.”, “Yamagami Bldg.”, “Ikeshita Bldg.” and “Kawanaka Bldg.”, in turn. Note that the loop task starts at S1003 and ends at S1007, and the loop task is repeatedly carried out from S1004 to S1006 for every base in turn.

At S1004, a reduction rate in crude oil equivalent for every solution in a base of interest is calculated. “Every solution” herein denotes combinations of every floor and every energy saving solution for a base of interest, and each of the combination is assigned with an ID number as shown in the “Elemental Effect Table” of FIG. 9A. Now, a reduction in crude oil equivalent for every solution in the “Elemental Effect Table” of FIG. 9A is converted into a reduction rate relative to total annual energy consumption through all the buildings. The reduction rate in crude oil equivalent (unit: %) is calculated with reference to a value of each reduction in crude oil equivalent for every solution in the “Elemental Effect Table” of FIG. 9A in turn, using Formula (12).

$$Reduction rate in crude oil equivalent ( \% ) = ( Reduction in crude oil equivalent / total annual consumption in crude oil equivalent through all the bases ) \times 100 \qquad Formula ( 12 )$$

Note that the reduction in crude oil equivalent is a value of the “Reduction in Crude Oil Equivalent” of the “Elemental effect Table” of FIG. 9A, and the total annual consumption in crude oil equivalent is a value calculated at S1001.

At S1005, a reduction rate of CO₂ emission for every solution in a base of interest is calculated. As similar to at S1004, CO₂ emission for every solution of the “Elemental Effect Table” of FIG. 9A is converted into a reduction rate relative to a total annual CO₂ emission through all the buildings. The reduction rate of CO₂ emission (unit: %) is calculated with reference to a value of CO₂ emission for every solution of the Elemental Effect Table of FIG. 9A in turn, using Formula (13).

$$Reduction rate of {CO}_{2} emission ( \% ) = ( {CO}_{2} reduction / total annual {CO}_{2} emission through all the bases ) \times 100 \qquad Formula ( 13 )$$

The CO₂ reduction corresponds to a value of a CO₂ reduction of the “Elemental Effect Table” of FIG. 9A, and the total annual CO₂ emission through all the bases is a value calculated at S1002.

At S1006, various values of the base name, floor, solution, installation cost and cost recovery period that are read from the “Elemental Effect Table” of FIG. 9A along with the reduction rate in crude oil equivalent calculated at S1004 and the reduction rate of CO₂ emission calculated at S1005 are recorded in the tables of the effect DB 0402 in turn. Then, the step at S1007 returns to the step at S1003 so as to repeat this loop task continuously. A table format of a table of the effect DB 0402 is described as follow.

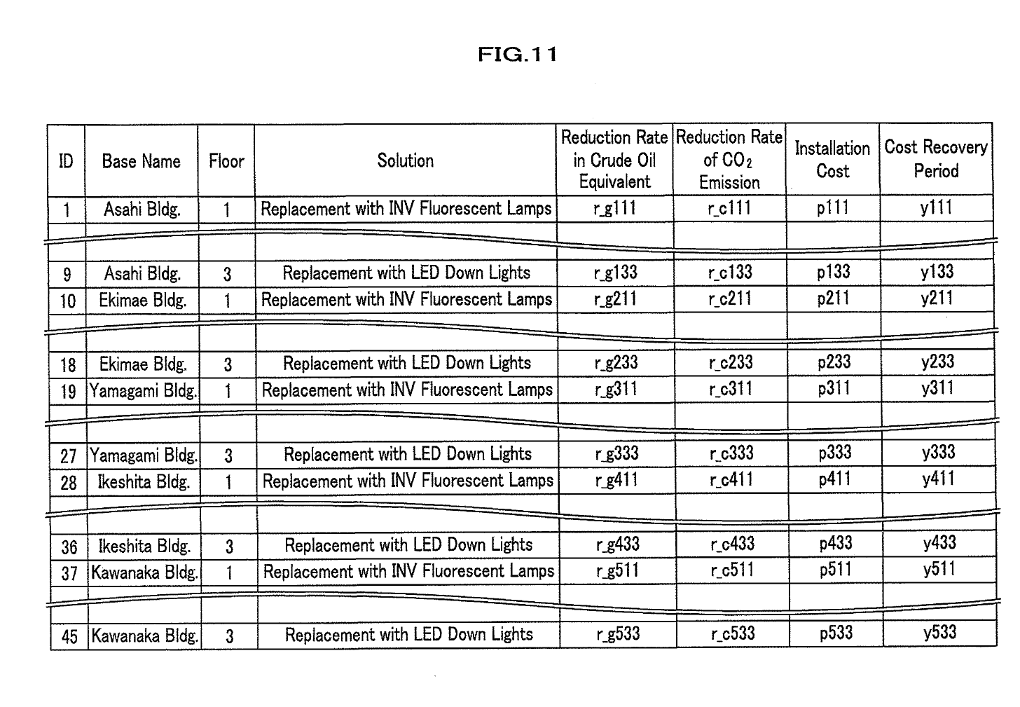

FIG. 11 shows a format of a table stored in the effect DB 0402, which is for storing data calculated on the reduction rate calculation function unit 0401. Elements of the table includes “ID”, “Base Name”, “Floor”, “Solution”, “Reduction Rate in Crude Oil Equivalent”, “Reduction Rate of CO₂ Emission”, “Installation Cost” and “Cost Recovery Period”. This exemplifies a case in which data is input in order of “Asahi Bldg.”, “Ekimae Bldg.”, “Yamagami Bldg.”, “Ikeshita Bldg.” and “Nakagawa Bldg.”. “g_r*** (* represents a numerical value)” denotes a reduction rate in crude oil equivalent calculated at S1004, “r_c*** (* represents a numerical value)” denotes a reduction rate of CO₂ emission calculated at S1005. Other values correspond to values in the table of FIG. 9A.

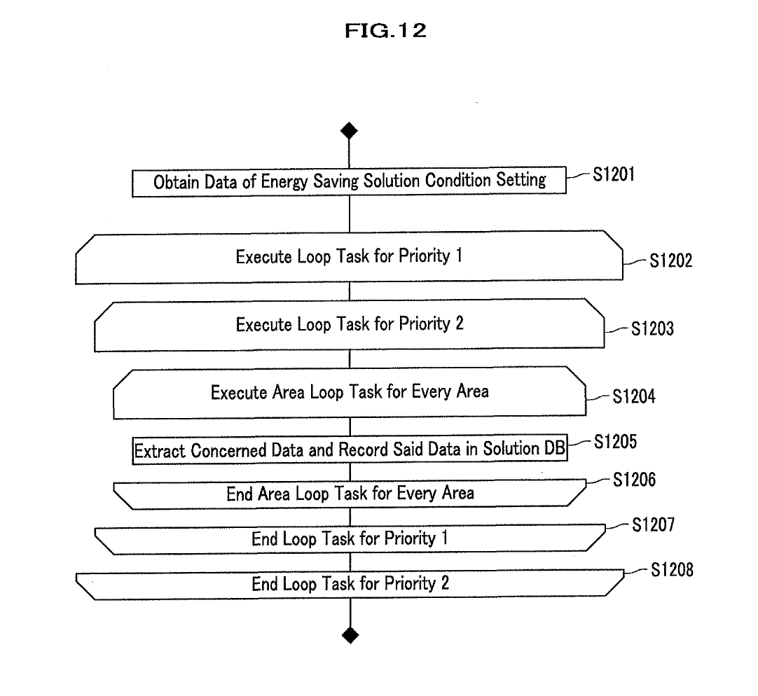

FIG. 12 shows a flow chart of the solution selection function unit 0403. This function serves for extracting data that satisfies conditions of an energy saving solution (3. Energy Saving Solution Condition Setting of FIG. 6) in accordance with users need set by a user in the user setting section 0202, and for storing the extracted data in the solution DB 0404.

At S1201, data of 3. Energy Saving Solution Condition Setting of FIG. 6 is obtained. Specifically, in the above context of the explanations, the priority order of base selection is as follows:
Priority 1: Ekimae Bldg.
Priority 2: Asahi Bldg.
Priority 3: Yamagami Bldg.

The priority order of energy saving solution selection is as follows:
Priority 1: Replacement with INV fluorescent lamps
Priority 2: Brightness Enhancement of emergency exit sign lamps
Priority 3: Replacement with LED down lights

In addition, the priority order of base selection is set in a higher priority than the priority order of energy saving solution selection.

At S1202, a loop task is carried out for the priority 1. Specifically, a loop task is carried out in turn for the priority 1 set in (3) Priority Order of Conditions of FIG. 6. In this case, “(1) Priority Order of Base Selection for Energy Saving Solution” has the priority 1, thus this loop task is carried out in order of “Ekimae Bldg.”, “Asahi Bldg.” and “Yamagami Bldg.”. The loop task ends at S1208.

At S1203, a loop task is carried out for the priority 2. Specifically, a loop task is carried out in turn for the priority 2 set in (3) Priority Order of Conditions of FIG. 6.

In this case, “(2) Energy Saving Solution Selection.” has the priority 2, thus this loop task is carried out in order of “Replacement with INV Fluorescent Lamps”, “Brightness Enhancement of Emergency Exit Sign lamps” and “Replacement with LED Down Lights”. The loop task ends at S1207.

At S1204, an area loop task is carried out. Specifically, all the buildings are set to be a three story building, so that the loop task is carried out from the first floor to the third floor. Note that this loop task ends at S1206.

At S1205, records that satisfy a condition of the loop task for the priority 1 at S1202, a condition of the loop task for the priority 2 at S1203 and a condition of the area loop task at S1204 are extracted from the effect DB 0402 in FIG. 11, and the extracted records are stored in turn in the solution DB 0404. Then, an area loop task is carried out at S1206, a loop task for the priority 2 is carried out at S1207 and a loop task for the priority 1 is carried out at S1208, respectively. A table format of a table of the solution DB 0404 is explained as follow.

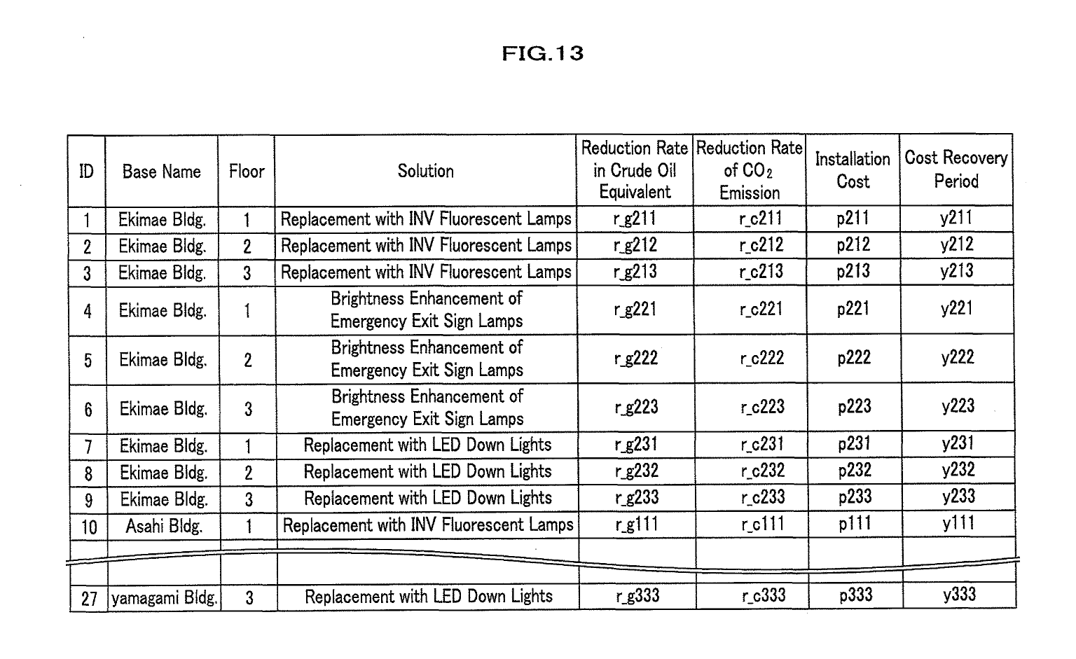

FIG. 13 shows a table format of a table that is stored in the solution DB 0404. Every element of the table is the same as that of the effect DB 0402 as shown in FIG. 11. This example illustrates 27 data, constituted by a combination of three bases (buildings) as the base selection in the priority order; three types of energy saving solutions as the energy saving solution selection in the priority order; and three floors of each building, are recorded. The order in this table reflects users need set in 3. Energy Saving Solution Setting Condition of FIG. 6, the ID number “1” has the highest priority level and the propriety level becomes lower as going downward.

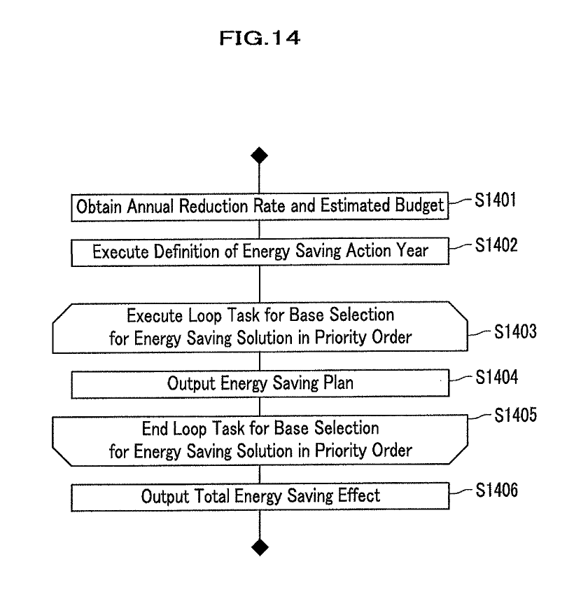

FIG. 14 shows a flow chart of the planning function unit 0405. This function serves for creating an energy saving plan for each base and output this plan based on the records stored in the solution DB 0404 in FIG. 13.

At S1401, an annual reduction rate and an estimated budget set by a user in the user setting section 0202 are obtained. A value of the reduction rate is a value for each year of (2) Annual Reduction Rate of 2. Annual Reduction Rate in FIG. 6. An estimated budget is a value of each year of 4. Estimated Budget.

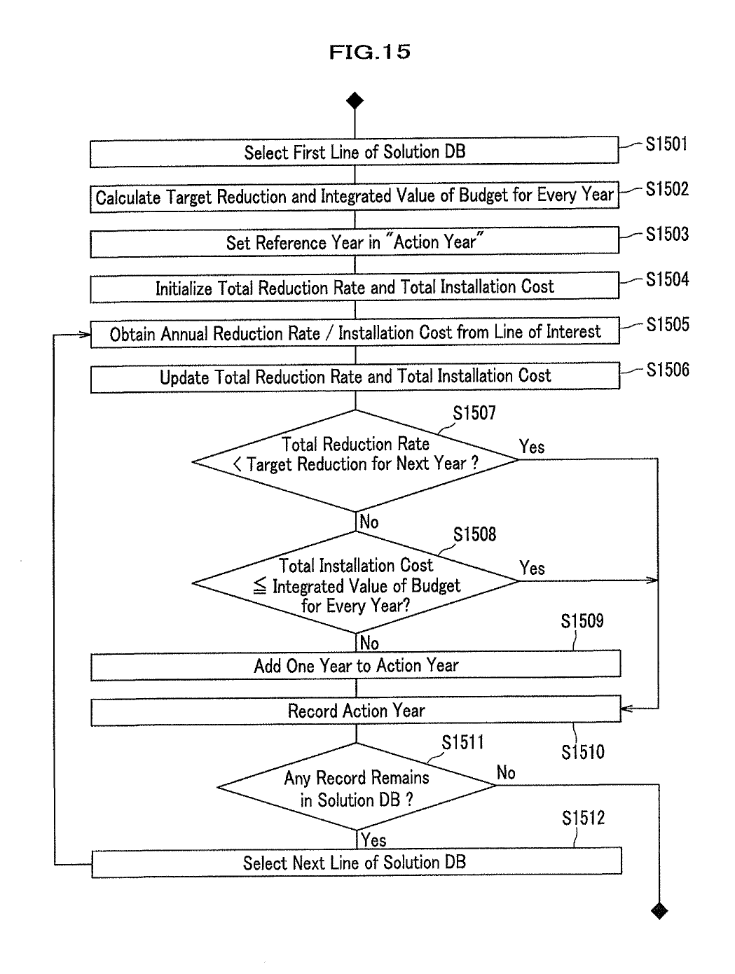

At S1402, definition operation for defining an energy saving action year is carried out. Specifically, it is defined when an energy saving solution of interest assigned with each ID number stored in the solution DB 0404 should be carried out. FIG. 15 shows a flow chart of detailed steps of this operation. Explanations for FIG. 15 will be given hereinafter.

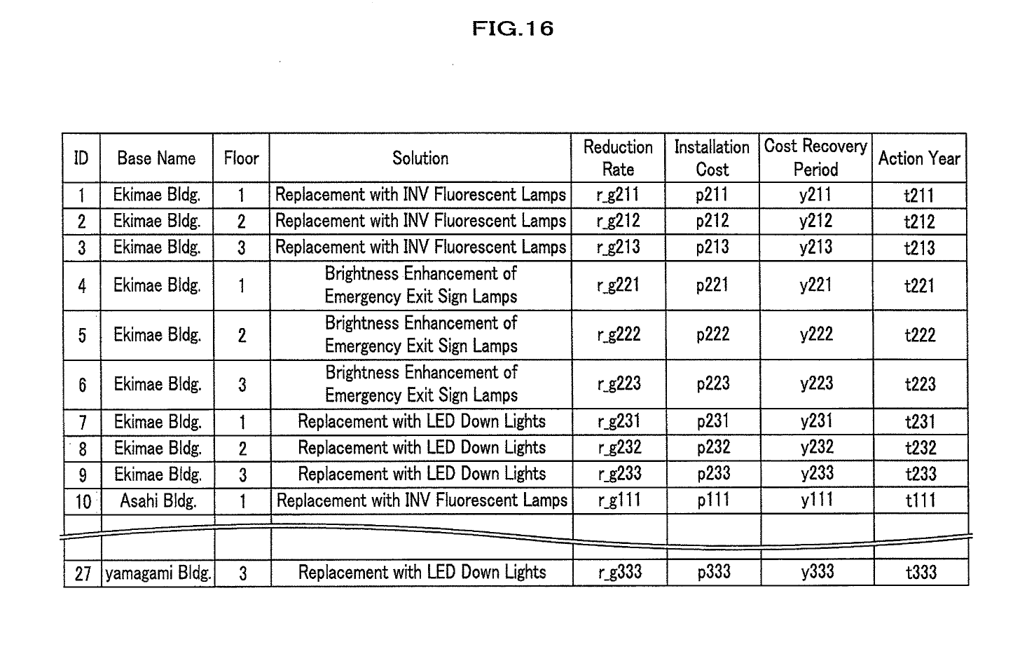

FIG. 15 is a flow chart of the “Definition of Energy Saving Action Year” step (S1402) of FIG. 14. FIG. 16 shows a table format of an output table for the “Definition of Energy Saving Action Year” step (S1402) of FIG. 14.

At S1501, the first line (ID=1) of the table of the solution DB 0404 (FIG. 13) is selected as a line of interest to be processed in this case.

At S1502, calculations for a target reduction for every year and an integrated value of budget for every year are carried out. First, the annual reduction rate for every year obtained at S1401 is converted into a target reduction (unit: %) for every year using Formula (14). Then, an estimated budget for every year obtained at S1401 is converted into an integrated value of budget for every year (unit: ten thousand yen), using Formula (15).

Target reduction for every year (%)=Summation of annual reduction rates from the reference year to a specified year Formula (14)

Integrated value of budget for every year(ten thousand yen)=Estimated budget for every year from the reference year to a specified year Formula (15).

In this case, as for the target reduction for ever year, the reference year is set to be the year 2009, and the specified year is set to be the year 2019, and then the target reduction is calculated for every year from 2009 to 2019. Note that the above calculation is carried out such that the annual reduction rate for the reference year is set to be 0%. As for the integrated value of budget for every year, the reference year is set to be the year 2009 and the specified year is set to be the year 2018, and then the integrated value of budget is calculated for every year from 2009 to 2018.

At S1503, “2009” which is the reference year is set in the variable “Action Year”.

At S1504, 0(%) is set in the variable “Total Reduction Rate” and 0 (yen) is set in the variable “Total Installation Cost” for initialization.

At S1505, a value for the reduction rate in crude oil equivalent (if “Crude Oil Equivalent” is selected in 1. Target Energy Saving of FIG. 6) or the reduction rate of CO₂ emission (if “CO₂ Emission” is selected in 1. Target Energy Saving of FIG. 6) is obtained from the line of interest of the solution DB 0404. For example, if the above line of interest is the first line of FIG. 13, a value of r_g211“ ” (or “r_c211”) is obtained. As the installation cost, a value of “p211” is obtained.

At S1506 of “Updating Total Reduction Rate and Total Installation Cost”, the total reduction rate is calculated using Formula (16), and the total installation cost is calculated using Formula (17).

Total reduction rate=total reduction rate at present time+reduction rate obtained at S1505 Formula (16)

Total installation cost=total installation cost at present time+installation cost obtained at S1505 Formula (17)

In this case, the reduction rate obtained at S1505 is the reduction rate in crude oil equivalent (if “Crude Oil Equivalent” is selected in 1. Target Energy Saving of FIG. 6) or the reduction rate of CO2 emission (if “CO₂ Emission” is selected in 1. Target Energy Saving of FIG. 6).

At S1507, the variable “Total Reduction Rate” is compared with “Target Reduction for Every Year” calculated at S1502. It is assumed that an effect due to an installation of energy saving equipment or device will be brought about in a next year after the installation; therefore, in this case, it is set that the “Total Reduction Rate” is compared with the “Reduction Target for Next Year” (the target reduction to be achieved in the next year). If the variable “Total Reduction Rate” is not more than the “Target Reduction for Next Year”, the step proceeds to S1510, where data in a line of interest (the selected line) of the solution DB 0404 of FIG. 13 is stored in a corresponding field of the output table of FIG. 16, and the year recorded d in the variable “Action Year” is stored in a corresponding field of the action year of the output table of FIG. 16. Among the elements of the output table of FIG. 16, the fields of the ID, the base name, the floor, the solution, the installation cost, the cost recovery period are the same as those of the solution DB 0404 of FIG. 13, and in a corresponding field of the reduction rate, a value of the reduction rate in crude oil equivalent (if “Crude Oil Equivalent” is selected in 1. Target Energy Saving of FIG. 6) or the reduction rate of CO₂ emission (if “CO₂ Emission” is selected in 1. Target Energy Saving of FIG. 6), which is obtained at S1505, is recorded.

On the other hand, if the variable “Total Reduction Rate” becomes equal to or more than the “Target Reduction for Next Year”, it is determined that the reduction becomes sufficient so that the step proceeds to S1508. At S1508, the variable “Total Installation Cost” is compared with the “Integrated Value of Budget for Every Year”. This comparison is carried out after setting both units to be equal. If the variable “Total Installation Cost” is equal to or less than the “Integrated Value of Budget of Every Year”, which means that the total reduction rate clears the target reduction, but the budget still has leeway, it is deemed that the energy saving solution stored in the line of interest (the selected line) will be carried out in the year of interest, so that the step proceeds to S1510, where data in the line of interest (the selected line) of the solution DB 0404 of FIG. 13 is stored in a corresponding field of the output table of FIG. 16, and the year set in the variable “Action Year” is stored in filed of the “Action Year” of the output table of FIG. 16. Thus, an energy saving solution can be carried out ahead of schedule with the budget left behind as little as possible, and the target reduction can be cleared more easily in and after the next year.

At S1508, the variable “Total Installation Cost” exceeds the “Integrated Value of Budget for Every Year”, the step proceeds to S1509 so as to carry out an energy saving solution in the line of interest (the selected line) in the next year, and at S1509 the variable “Action Year” is rewritten to be one year ahead. At S1510, data in the line of interest (the selected line) of the solution DB 0404 of FIG. 13 is stored in a corresponding filed of the output table of FIG. 16, and a year set in the variable “Action Year” (“Add One Year to Action Year” at S1509) is stored in a corresponding field of the “Action Year” of the out table of FIG. 16.

At S1511, if any record remains in the solution DB 0404 of FIG. 13, the step proceeds to S1512. At S1512, data in the next line of the solution DB 0404 is selected, and the step returns to S1505. On the other hand, if no record remains at S1511, the step is completed (proceeding to S1402 for the “Definition for Defining Energy Saving Action Year”). At this stage, the output table of FIG. 16 is filled with all the records. Note that elements of the output table of FIG. 16 having the same element names as those of the solution DB 0404 of FIG. 13 represent both the elements store the same data. In addition, the reduction rate is represented in the reduction rate in crude oil equivalent (r_g***, * represents a numerical value) because “Crude Oil Equivalent” is selected in 1. Target Energy Saving of FIG. 6.

Returning to FIG. 14, at S1403 a loop task for the “Base Selection for Energy Saving Action in Priority Order” is set. In this case, the loop task is carried out in order of “Ekimae Bldg.”, “Asahi Bldg.” and “Yamagami Bldg.”, which is the order of the “Base Selection for Energy Saving Action in Priority Order” set in FIG. 6. This loop task ends at S1405.

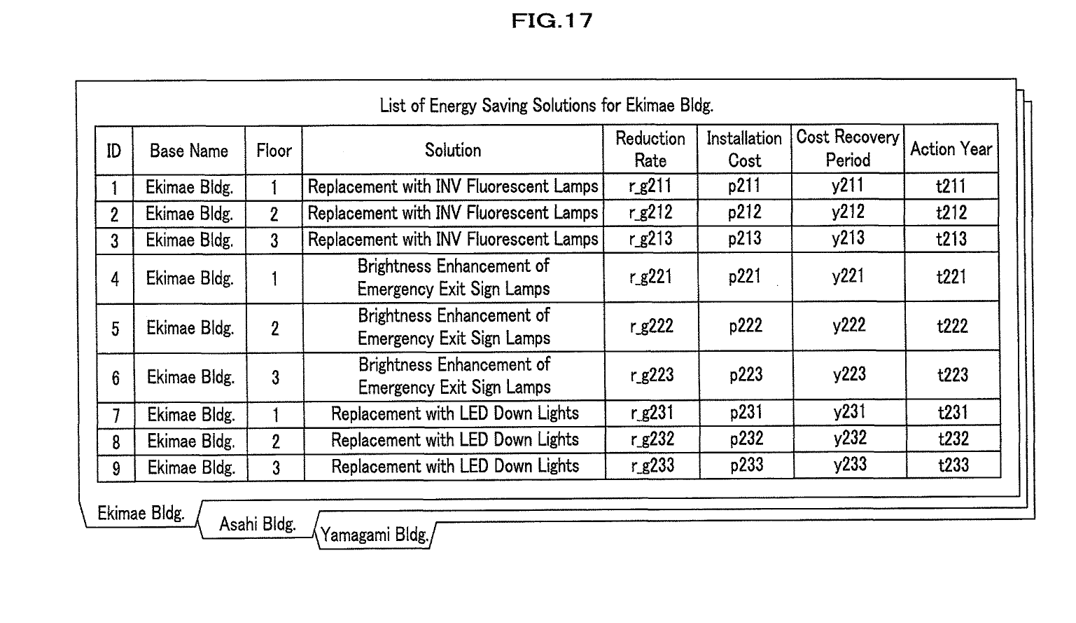

At S1404, data for a base of interest in this loop task is extracted from data stored in the output table of FIG. 16, and is stored in a table format as shown in FIG. 17, as described later on. Through the loop task from S1403 to S1405, it is possible to create an energy saving plan for each base where an energy saving solution is carried out in the priority order.

FIG. 17 shows an example of a list of energy saving solutions for each base, which is output by the present invention. The list of FIG. 17 is output results of data from the output data base of FIG. 16 with tabs for representing the bases, in each of which an energy saving solution is carried out in the priority order. Data of FIG. 17 having the same element name as those of FIG. 16 represents the same data with each other. Then, these tables are output to the output function unit 0104 so as to represent them to the user. FIG. 17 shows only data selected by the tab of the “Ekimae Bldg.”, but other tabs for “Asahi Bldg.” and “Yamagami Bldg.” may also be clicked so as to display and confirm data of the “Asahi Bldg.” and “yamagami Bldg.”. These tables represents an energy saving plan created in accordance with users need, so that the user can achieve the target reduction simply by carrying out in each base an energy saving solution represented in this list of the energy saving solutions in a year represented in an action year of interest listed in the list of energy saving solutions.

As explained above, for every year, the consolidation section 0206 adopts energy saving solutions set in the elemental effect table of FIG. 9A as the energy saving solutions to be introduced in an action year of interest in the priority order (such as the priority order of base selection for energy saving action; the priority order of energy saving solution selection; and the priority order of conditions) specified by the users need, so that total effects of the adopted energy saving solutions can clear the target reduction to be achieved in the next year after the year when the energy saving solutions are carried out, and represents to a user an energy saving plan that specifies energy saving equipment or devices to be installed and when to install the equipment.

In the flow charts of FIG. 12 and FIG. 15, data is not extracted or selected by directly referring to the elemental effect table of FIG. 9A when defining the action year in the priority order specified by the users need; but only data is allocated only by exchanging and or extracting the data when creating the effect DB 0402 and the solution DB 0404, which is substantially equal to indirectly referring to the elemental effect table of FIG. 9A. Thus, this is the reason why the above description is used in such expressions: “(the consolidation section 0206) adopts energy saving solutions set in the elemental effect table of FIG. 9A as the energy saving solutions to be introduced in an action year of interest in the priority order (such as the priority order of base selection for energy saving action; the priority order of energy saving solution selection; and the priority order of conditions) specified by the users need”.

Note that the above configurations of the embodiment are illustrated as an example of the present invention, and data may be extracted or selected by directly referring to the elemental effect table of FIG. 9A when defining the action year in the order specified by users need.

If any one of the “priority order of base selection for energy saving action”, the “priority order of energy saving solution selection”, the “priority order of conditions” and the “estimated budget” is not input according to the users need, this non-input item may be considered to have no limitation and the planning may be created based on such a consideration.

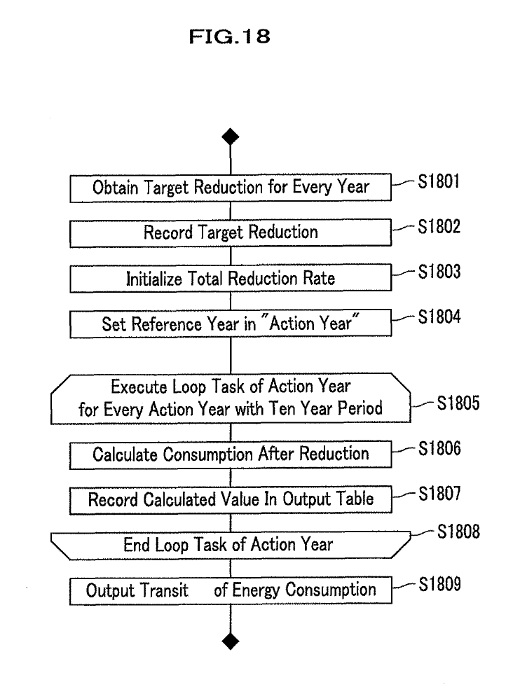

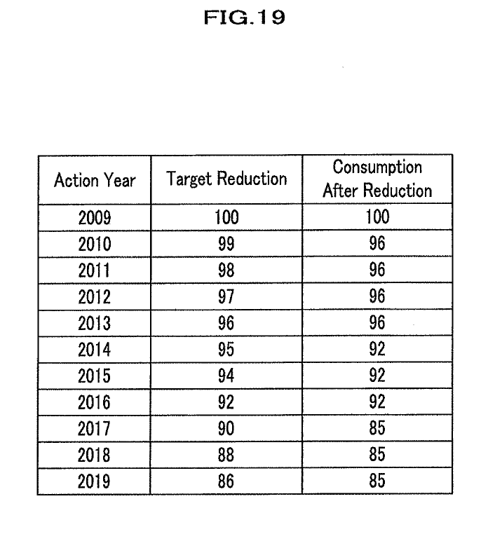

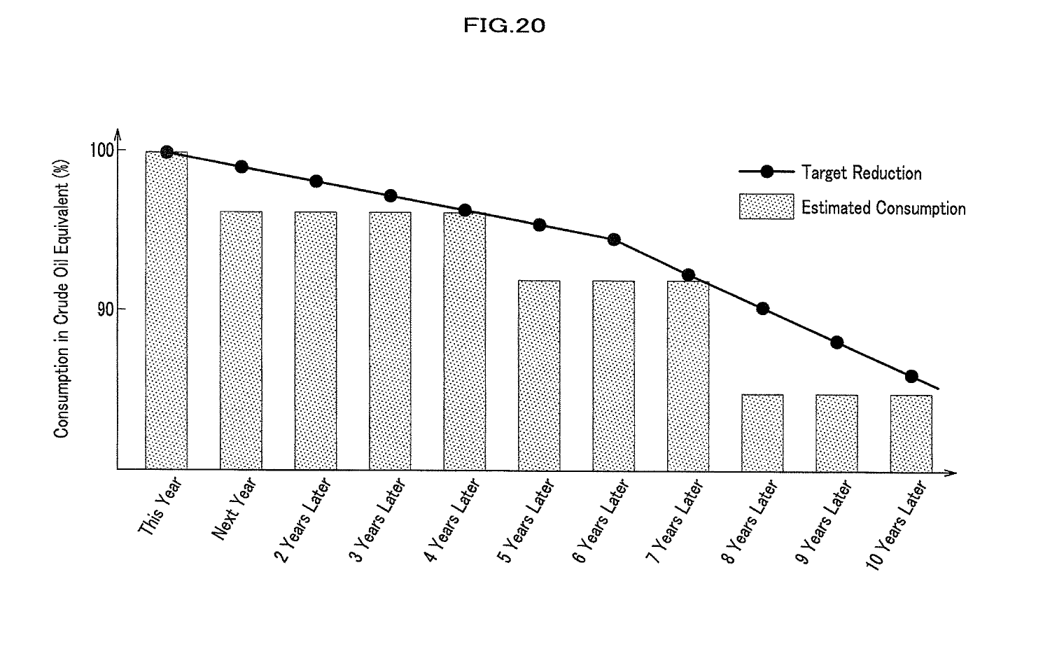

At S1406 for “Output Total Energy Saving Effect”, a total energy saving effect through all the bases including bases other than the target bases where energy saving solutions are carried out is calculated and a transit of the total energy consumption is outputted, based on the energy saving plan created at S1404. FIG. 18 shows a flow chart of this block, and FIG. 19 shows a table format of an output table of this block, and FIG. 20 shows a graph of FIG. 19, respectively.

At S1801, the target reduction for every year calculated at S1502 is obtained.

At S1802, a value obtained by subtracting the target reduction for every year from 100 is recorded in each field in and after the year 2010 of the output table of FIG. 19. In the field of the reference year 2009, 100(%) is recorded in advance.

At S1803, the variable “Total Reduction Rate” is initialized by setting a value “0” therein.

At S1804, the reference year (the year 2009 in this case) is set in the variable “Action Year”.

At S1805, a loop task of action year is set. Herein, this loop task is set to be executed for every action year from the year 2009 to the year 2019 (ten year period). The above year period may be set to be a year period for outputting the transit of total energy consumption through the plural bases. The number of records for the action years of FIG. 19 may be set in accordance with the number of loops of this loop function. This loop task ends at S1808.

At S1806, in the output table of FIG. 16 that is output at S1402, reduction rates from the reference year to the year of interest where this loop task is carried out are summed up. A value obtained by subtracting this summed value from 100 is recorded in a filed of the “Consumption After Reduction” in a line of a next year after the year of interest when this loop task is carried out (S1807). In this example, the above value is set to be recorded in a line of a next year after the year of interest because it is assumed that an effect of an energy saving action carried out in a certain year (the year 2009, for example) will be brought about in a next year after this certain year (i.e. the year 2010). Note that the “Consumption After Reduction” for the reference year (the year 2009) is recorded to be 100(%) in advance. Since there is no field for recording a result of the loop task for the last year 2019, a field for the year 2020 may be created for this recording. Alternatively, the year period when the loop task is carried out may be reduced by one year and set to be nine years, so that the loop task may be carried out from the reference year (the year 2009) to the year 2018.

As such, empty fields of the table of FIG. 19 is completely filled with data.

The above loop task of action year ends at S1808.

At S1809, data of FIG. 19 is graphically illustrated in a form of a transit of the energy consumption as shown in FIG. 20, and then is output to the output function unit 0104. In the graph of FIG. 20, the horizontal axis represents the “Years” and the vertical axis represents the “Consumption in Crude Oil Equivalent” (unit: %). The line plot represents values in the fields of the target reduction of FIG. 19. Each of the target reductions of FIG. 19 and FIG. 20 corresponds to a target value of an energy consumption rate (%) after a reduction to be achieved in a year of interest is achieved, with reference to the energy consumption in the reference year. On the other hand, each bar chart of FIG. 20 represents an estimated consumption for every year (estimated energy consumption), and corresponds to a value of the “Consumption After Reduction” of FIG. 19. Accordingly, a user can know an effect of energy saving due to the energy saving plan that has been created.

This example illustrates a case in which a transit of the energy consumption through all the plural bases is output along with the target reduction, but is not limited to this. Other values regarding budget and or cost such as an integrated value of budget for every year may be graphically illustrated to suggest this to a user.

Returning to FIG. 14, the descriptions for the flow chart of the planning function unit 0405 are completed now.

Primary effects of the present invention are as follow.

According to the present invention, it is possible to create and suggest to a user an energy saving plan to select an energy saving solution to continuously clear an annual energy saving target in accordance with the Law Concerning the Rational Use of Energy and a time to introduce this selected solution with consideration through plural bases in total, also in accordance with users need wishing to preferentially carry out an energy saving solution on a particular base such as an energy saving model building; wishing a priority order in selecting an energy solution (energy saving equipment or devices); or wishing to leave budget behind as little as possible if the budget for the energy saving action is estimated in advance.

According to the present invention, in order to clear a energy saving target becoming severer and severer year by year, it is also possible to suggest to a user an energy saving solution that can be carried out ahead of schedule with the budget left behind as little as possible when the budget has leeway, and that can be minimized to clear the target reduction when the budget has no leeway, thereby to reduce user's economic load.

In addition, the user can know an effect due to the energy saving action.

Other effects of the present invention will be apparent from the above descriptions through the specification.

The present invention has been described above by using various examples of the embodiment, and each configuration, component and element used in the above explanations is just for showing an example, and the present invention may be appropriately modified without departing from the spirit and scope of the invention.

The embodiment according to the present invention has been explained as aforementioned. However, the embodiment of the present invention is not limited to those explanations, and those skilled in the art ascertain the essential characteristics of the present invention and can make the various modifications and variations to the present invention to adapt it to various usages and conditions without departing from the spirit and scope of the claims.

What is claimed is:

1. An energy saving assistance system including a program that runs on at least one computer, and creating an energy saving plan for defining time when to introduce an energy saving solution implemented by installing an energy saving equipment,
the program comprising:
a user setting section for setting as users need a target reduction of energy consumption through all of plural bases for every year and a priority order of selecting from the plural bases a base where an energy saving solution is preferentially carried out;
an elemental effect calculation section for calculating an energy effect of every energy saving solution for a base of interest among the bases where the energy saving solution is preferentially carried out in the priority order, with reference to a data base storing equipment information before installing the energy saving equipment for the base of interest and a data base storing specifications of the energy saving equipment for the base of interest, and this calculation of the energy saving effect of every energy saving solution being carried out for every base of the bases where the energy saving solution is preferentially carried out in the priority order, and outputting the calculated energy saving effect of every energy saving solution for every base in a form of an elemental effect table; and
a consolidation section for creating the energy saving plan in accordance with the users need, using the elemental effect table, and representing this energy saving plan to the user, and
for every action year, the consolidation section adopting an energy saving solution set in the elemental effect table as the energy saving solution to be introduced in an action year of interest in the priority order of base selection for the energy saving solution, so that total energy saving effect due to the adopted energy saving solution can clear a target reduction to be achieved in a next year after a year when the energy saving solution is carried out, and represents to the user an energy saving plan that specifies an energy saving equipment to be installed and a year when to install the equipment.

2. The energy saving assistance system as claimed in the claim 1, wherein
the user setting section has a function for setting an estimated budget for every year as the users need, and
although the total energy saving effects due to the adopted energy saving solutions clear the target reduction to be achieved in the next year after the year when the energy saving solution is carried out, but if total installation cost of the energy saving equipment installed is less than a total estimated budget for every year up to the action year, the consolidation section installs an additional energy saving solution in the action year of interest in a range in which the total installation cost of the energy saving equipment installed does not exceed the total estimated budget for every year up to the action year of interest.

3. The energy saving assistance system as claimed in the claim 2, wherein
if the total installation cost of the energy saving equipment installed is more than the total estimated budget for every year up to the action year of interest, the consolidation section defines a year when to install the energy saving equipment so that the total energy saving effect due to the adopted energy saving solutions barely clear the target reduction to be achieved in the next year of the action year of interest.

4. The energy saving assistance system as claimed in the claim 1, wherein
the consolidation section defines a year when to install the energy saving equipment so that the total energy saving effect due to the adopted energy saving solutions barely clears the target reduction to be achieved in the next year of the action year of interest.

5. The energy saving assistance system as claimed in the claim 1, wherein
the user setting section has a function for setting a priority order of selecting the energy saving equipment to be preferentially installed from plural energy saving equipments, and setting a priority order of conditions to define which of a priority order of selecting a base where the energy saving solution is preferentially carried out or the priority order of selecting the energy saving equipment to be preferentially installed is given a higher priority, and
for every action year, the consolidation section adopts the energy saving solution in the elemental effect table as the energy saving solution to be installed in the next year after the action year of interest in an order that satisfies the priority order of selecting the base where the saving energy solution is preferentially carried out, the priority order of selecting the energy saving solution to be preferentially carried out and the priority order of the conditions, so that the total energy saving effect due to the adopted energy saving solution clears the target reduction to be achieved in the next year after the action year of interest, and represents to a user the energy saving plan to define the energy saving equipment for the every base of the bases where the energy saving solution is preferentially carried out and the year when to install the energy saving equipments.

6. The energy saving assistance system as claimed in the claim 1, wherein
the consolidation section sums up energy consumptions after the energy saving solutions are carried out for the every base, and outputs the summation of the energy consumptions along with target values as a transit of an energy consumption through all the plural bases.

7. The energy saving assistance system as claimed in the claim 1, wherein
the consolidation section converts at least one of the energy saving effect for every energy saving solution in the elemental effect table and the target reduction of the energy consumption through all the plural bases for every year, so as to compare both the energy saving effect for every energy saving solution and the target reduction for every year with each other.

8. The energy saving assistance system as claimed in the claim 1, wherein
quantity in crude oil equivalent or CO₂ emission is used as an index of the energy consumption.

9. The energy saving assistance system as claimed in the claim 1, wherein
a reduction rate is used as the target reduction for every year.

10. The energy saving assistance system as claimed in the claim 1, wherein
the computer comprises a server computer and a client computer, which are coupled with each other via a network; and
an input of the users need on the user setting section is executed on the client computer, and
the energy saving effect is calculated on the elemental effect calculation section and the year when to install the energy saving equipment is defined on the server computer.

11. The energy saving assistance system as claimed in the claim 1, wherein
both the calculation of the energy saving effect and the definition of the year when to install the energy saving equipment are executed on a single computer.

12. An energy saving assistance program running on at least one computer and creating an energy saving plan for defining time when to introduce an energy saving action implemented by installing energy saving equipment,
the program comprising:
a user setting section for setting as users need a target reduction of energy consumption through all of plural bases for every year and a priority order of selecting from the plural bases a base where an energy saving solution is preferentially carried out;
an elemental effect calculation section for calculating an energy effect of every energy saving solution for a base of interest among the bases where the energy saving solution is preferentially carried out in the priority order, with reference to a data base storing equipment information before installing the energy saving equipment for the base of interest and a data base storing specifications of the energy saving equipment for the base of interest, and this calculation of the energy saving effect of every energy saving solution being carried out for every base of the bases where the energy saving solution is preferentially carried out in the priority order, and outputting the calculated energy saving effect of every energy saving solution for every base in a form of an elemental effect table; and
a consolidation section for creating the energy saving plan in accordance with the users need, using the elemental effect table, and representing this energy saving plan to the user, and
for every action year, the consolidation section adopting an energy saving solution set in the elemental effect table as the energy saving solution to be introduced in an action year of interest in the priority order of base selection for the energy saving solution, so that total energy saving effect due to the adopted energy saving solution can clear a target reduction to be achieved in a next year after a year when the energy saving solution is carried out, and represents to the user an energy saving plan that specifies an energy saving equipment to be installed and a year when to install the equipment.
